(19) United States
(12) Patent Application Publication
(10) Pub. No.: US 2024/0118679 A1
(43) Pub. Date: Apr. 11, 2024

(54) VIRTUAL CONTROLLER DEPLOYED ON INTRINSICALLY SAFE FIELD DEVICE

(71) Applicant: Schneider Electric Systems USA, Inc., Foxborough, MA (US)

(72) Inventors: Larry K. Brown, Casper, WY (US); Mark V. Bertolina, Milton, MA (US); Harikrishnan Baskaran, North Attleboro, MA (US); Briane Ritchie, Bellingham, MA (US); Ashutosh Diliprao Katke, Pune, Maharashtra (IN)

(73) Assignee: Schneider Electric Systems USA, Inc., Foxborough, MA (US)

(21) Appl. No.: 18/484,027

(22) Filed: Oct. 10, 2023

Related U.S. Application Data
(60) Provisional application No. 63/414,842, filed on Oct. 10, 2022.

(51) Int. Cl. G05B 19/4155

(52) U.S. Cl. CPC G05B 19/4155; G05B 2219/31449

(57) ABSTRACT

An Intrinsically Safe (IS) Advanced Physical Layer (APL) based low power field device having a virtual controller implemented thereon. The virtual controller provides distributed control and one or more of historian, workstation, and HMI functionality on the field device.

### CROSS-REFERENCE TO RELATED APPLICATION

This application claims priority to U.S. Provisional Patent Application No. 63/414,842, filed Oct. 10, 2022, the entire disclosure of which is incorporated herein by reference.

### FIELD

The present disclosure relates generally to field devices, and more particularly, to systems and methods relating to a virtual controller deployed intrinsically safe constrained field device.

### BACKGROUND

As is known, an industrial operation or plant typically includes industrial equipment often in a variety of forms and associated with various processes, for example, depending on the industrial operation. For example, an industrial operation may include one or more field devices (e.g., remote terminal units (RTUs), programmable logic controllers (PLCs), actuators, sensors, human-machine interfaces (HMIs)) that are used perform, analyze and/or control process variable measurements. These process variable measurements may include pressure, flow, level, and temperature, for example. The industrial operation or plant, and its associated equipment and process(es), are in some instances operated and controlled using a Distributed Control System (DCS).

Conventional methods and systems for distributed control and historian/workstation/HMI functionality have generally been considered satisfactory for their intended purpose but there is still a need in the art for improvements, including an intrinsically safe device capable of providing virtual control.

### SUMMARY

Aspects of the present disclosure relate to a virtual controller deployed on an intrinsically safe constrained field device that allows distributed control and historian, workstation/HMI functionality traditionally supported in Layer 1 of the Purdue Model and above to also be deployed to Layer 0 field devices. In this manner, aspects of the present disclosure permit field devices to manage resources rather than being single purpose elements in the system.

In an aspect, an IS APL based low power field device includes a processor and a memory. The memory stores processor-executable instructions that, when executed, configure the processor to implement a virtual controller on the field device. The virtual controller is configured to provide distributed control and one or more of historian, workstation, and HMI functionality on the field device. In another aspect, a method includes implementing a virtual controller on an IS APL based low power field device and providing distributed control and one or more of historian, workstation, and HMI functionality on the field device.

Other objects and features of the present invention will be in part apparent and in part pointed out herein.

### BRIEF DESCRIPTION OF THE DRAWINGS

FIG. 1 illustrates an example industrial operation in accordance with embodiments of the disclosure.

FIG. 2 illustrates an example APL field device in accordance with embodiments of the disclosure.

Corresponding reference characters indicate corresponding parts throughout the drawings.

### DETAILED DESCRIPTION

The features and other details of the concepts, systems, and techniques sought to be protected herein will now be more particularly described. It will be understood that any specific embodiments described herein are shown by way of illustration and not as limitations of the disclosure and the concepts described herein. Features of the subject matter described herein can be employed in various embodiments without departing from the scope of the concepts sought to be protected.

Embodiments in accordance with the present disclosure move aspects of field devices, such as a PLC, up the Purdue Model stack and move aspects of an industrial control system, such as a DCS, down the Purdue Model stack. Some of these aspects are moved to the cloud/micro-datacenter while other parts move to the field device. In an embodiment, the field device comprises a mini-control engine, historian, workstation/HMI, etc. embedded in an intrinsically safe (IS) device to be used in conjunction with the cloud aspects.

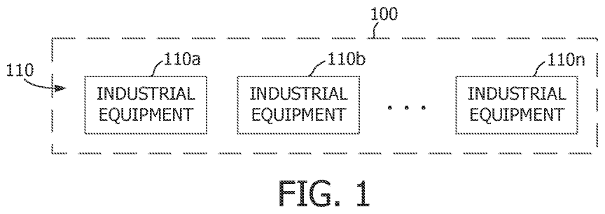

Referring to FIG. 1, an example industrial operation 100 in accordance with embodiments of the disclosure includes a plurality of industrial devices, or equipment, 110a, 110b, . . . , 110n (indicated collectively as industrial equipment 110). The industrial equipment (or devices) 110 may be associated with a particular application (e.g., an industrial application), applications, and/or process(es). The industrial equipment 110 may include electrical or electronic equipment, for example, such as machinery associated with the industrial operation 100 (e.g., a manufacturing or natural resource extraction operation). The industrial equipment 110 may also include the controls and/or ancillary equipment associated with the industrial operation 100, for example, field devices (e.g., RTUs, PLCs, actuators, sensors, HMIs) that are used perform, analyze and/or control process variable measurements. In embodiments, the industrial equipment 110 may be installed or located in one or more facilities (i.e., buildings) or other physical locations (i.e., sites) associated with the industrial operation 100. The facilities may correspond, for example, to industrial buildings or plants. Additionally, the physical locations may correspond, for example, to geographical areas or locations.

The industrial equipment 110 may each be configured to perform one or more tasks in some embodiments. For example, at least one of the industrial equipment 110 may be configured to produce or process one or more products, or a portion of a product, associated with the industrial operation 100. Additionally, at least one of the industrial equipment 110 may be configured to sense or monitor one or more parameters (e.g., industrial parameters) associated with the industrial operation 100. For example, industrial equipment 110a may include or be coupled to a temperature sensor configured to sense temperature(s) associated with the industrial equipment 110a, for example, ambient temperature proximate to the industrial equipment 110a, temperature of a process associated with the industrial equipment 110a, temperature of a product produced by the industrial equipment 110a, etc. The industrial equipment 110a may additionally or alternatively include one or more pressure sensors, flow sensors, level sensors, vibration sensors and/or any number of other sensors, for example, associated the application(s) or process(es) associated with the industrial equipment 110a. The application(s) or process(es) may involve water, air, gas, electricity, steam, oil, etc. in one example embodiment.

The industrial equipment 110 may take various forms and may each have an associated complexity (or set of functional capabilities and/or features). For example, industrial equipment 110a may correspond to a “basic” industrial equipment, industrial equipment 110b may correspond to an “intermediate” industrial equipment, and industrial equipment 110n may correspond to an “advanced” industrial equipment. In such embodiments, intermediate industrial equipment 110b may have more functionality (e.g., measurement features and/or capabilities) than basic industrial equipment 110a, and advanced industrial equipment 110n may have more functionality and/or features than intermediate industrial equipment 110b. For example, in embodiments industrial equipment 110a (e.g., industrial equipment with basic capabilities and/or features) may be capable of monitoring one or more first characteristics of an industrial process, and industrial equipment 110n (e.g., industrial equipment with advanced capabilities) may be capable of monitoring one or more second characteristics of the industrial process, with the second characteristics including the first characteristics and one or more additional parameters. It is understood that this example is for illustrative purposes only, and likewise in some embodiments the industrial equipment 110a, 110b, 110n, etc. may each have independent functionality.

As described above, the industrial operation 100, and its associated equipment and process(es), may be operated and controlled using a DCS in some instances.

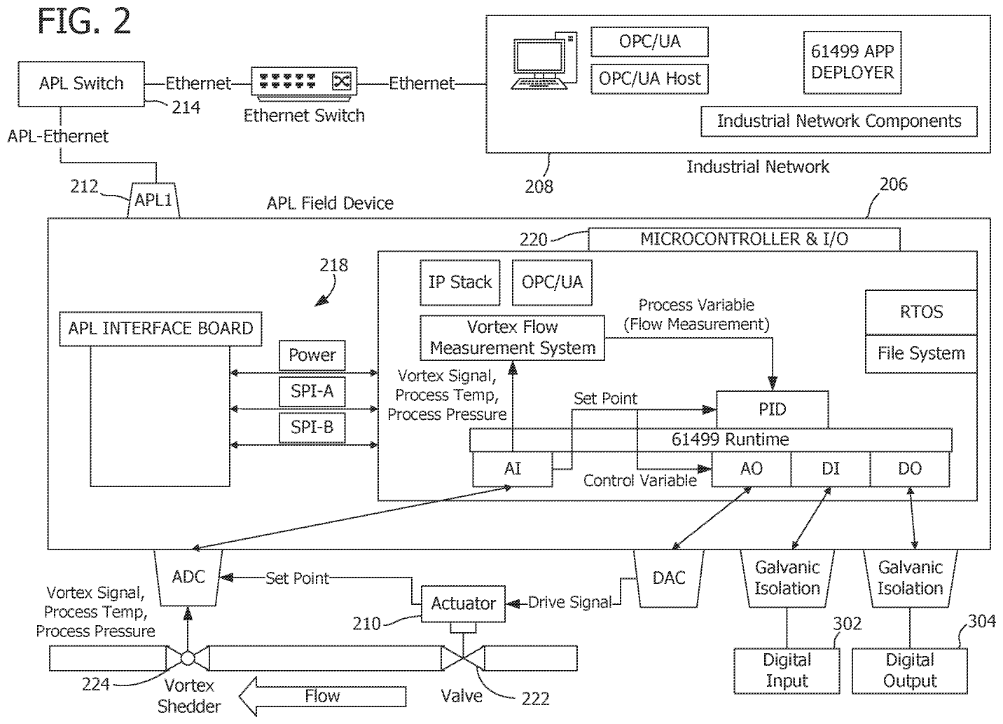

FIG. 2 shows an example Ethernet-APL field device 206 in accordance with embodiments of the present disclosure. The field device 206 utilizes APL, which is a specific single-pair Ethernet (SPE) based on 10BASE-T1L, to provide communication between an industrial network 208, such as the DCS mentioned above, and industrial equipment 110 (i.e., a Layer 0 device 210 such as an actuator in the illustrated embodiment). The APL field device 206 includes at least one physical APL 10BaseT1 port 212. The port 212 connects the field device 206 to the industrial network 208 via an APL switch 214.

In addition, APL field device 206 includes one or more of on-board Power over Data Lines (PoDL) components, power supply, network port, cable, and on-board network interface components indicated at 218. In this manner, the APL field device 206 of the illustrated embodiment allows a Layer 0 device 210 to connect over Ethernet-APL to an industrial Ethernet network 208 while maintaining intrinsic safety all the way to the APL switch 214.

In an embodiment, APL port 212 connects to APL switch 214 via 2-wire intrinsically safe Ethernet (2-WISE) 10BASE-T1L. The APL switch 214 in FIG. 2 combines communication technology with Ethernet-APL and permits transmitting power and data on an Ethernet wire into hazardous areas of a process plant. In a hazardous environment, power to field device 206 and device 210 is limited to an intrinsically safe threshold to reduce the risk of fire, explosions, or the like. The system of FIG. 2 includes a power limited source operatively connected to field device 206 and configured to supply a main power to device 210 up to a power limit threshold. In this instance, the power limited source comprises APL PoDL, which can be intrinsically safe.

Aspects of the present disclosure enable the deployment of distributed control in addition to historian, workstation/HMI functionality to Layer 0 field devices, such as the device 210, making them managed resources rather than single purpose elements in the system. Such functionality is traditionally supported in Layer 1 of the Purdue Model (e.g., PLC, DCS, RTU) and above rather than at Layer 0.

Embodiments in accordance with the present disclosure implement a virtual controller by encapsulating virtual PLC/DCS control in APL field device 206 using machine learning. The ML block can be created as a user defined block (using simple block or C function block, for example). This block provides an interface to local or I/O in the form of multiple inputs and outputs configured to be connected in the App/System/Strategy design for controlling and providing the monitoring/inspection features for the user. In this manner, APL field device 206 makes control, historian, HMI, etc. aspects available at the field device level. This way of implementing the ML block in IEC 61499 compliant runtime can provide greater flexibility for the 61499 system design. In addition, the disclosed implementation gives direct control to the user in logging the statistical data and/or manually overriding the ML block and as well as providing means for monitoring it.

In an embodiment, APL field device 206 supports both current-driven and voltage-driven analog measurements as well as supports HART (Highway Addressable Remote Transducer) and Modbus RTU/ASCII protocols, RS-485, RS-232, and SPI serial connections on the measurement interface. The APL field device 206 also provides Ethernet-based industrial protocols (e.g., OPC-FX, OPC-UA, Ethernet IP, Modbus TCP, HART-IP, PROFINET, CANopen, DeviceNet, Foundation Fieldbus, EtherCAT) on the side of industrial network 208. In the example of FIG. 2, the Layer 0 device 210 comprises an actuator responsive to an analog drive signal for operating a valve 222. A vortex meter 224 outputs an analog sensor signal representative of, for example, flow, temperature, and pressure. In operation, a microcontroller & I/O board 220 executes one or more control blocks for generating the drive signal as a function of the vortex signal. In an embodiment, requirements for the capabilities of the IS constrained APL field device 206 include, for example, resource management in conjunction with automated device operating system (OS) and application management in the Network or Cloud as well as device support for dynamic deployment of application/control functionality including binary distribution to the device 210 while operational. In this manner, aspects of the present disclosure permit virtual control as well as historian and HMI function elements to be deployed to APL field device 206, which is constrained such that it is intrinsically safe. Deployment to the power constrained APL field device 206 is subject to resource management without an OS or other standard resource managing utility inasmuch as they are incompatible with this type of constrained device. Advantageously, operation of the constrained device 206 as a managed resource is permitted for virtual Compute, Control, and I/O deployment within industrial network 208.

In an embodiment, an IS APL based low power field device comprises a virtual controller implemented on the field device. The virtual controller is configured to provide distributed control and historian, workstation/HMI functionality on the field device itself. With this distributed control and functionality, the field device is capable of managing resources in conjunction with automated device OS and application management in the Network or Cloud.

For convenience, certain introductory concepts and terms used in the specification are collected here.

As used herein, the term “Edge” is used to refer to Layer 0 of the Purdue Network Model for Industrial Control Systems.

As used herein, the term “Field Device” is used to refer to Equipment that is connected to the field side on an industrial control system. Types of field devices include RTUs, PLCs, actuators, sensors, HMIs, and associated communications as well as intelligent field instruments with embedded Control/Compute/measurement capability implemented on lower power embedded Microcontroller based platforms.

As used herein, the term “Machine Learning (ML)” is used to refer to the use and development of software that is able to learn and adapt without following explicit instructions, by using algorithms and statistical models to analyze and draw inferences from patterns in data.

As used herein, the term “Embedded Device” is used to refer to a combination of a microcontroller, memory, and input/output peripherals—that has a dedicated function within a larger system.

As used herein, the term “Networked” is used to refer to connected via Ethernet.

As used herein, the term “High availability” is used to refer to a device or application that can operate at a high level, continuously, without intervention, for a given time period. High-availability infrastructure is configured to deliver quality performance and handle different loads and failures with minimal or zero downtime.

As used herein, the term “Intrinsically Safe (IS)” is used to refer to an approach to the design of equipment going into hazardous areas that reduces the available energy to a level where it is too low to cause ignition as certified by per IEC TS 60079-39 or ATEX.

It is understood that aspects of the present disclosure may be found suitable for use in numerous applications, including but not limited to Oil and Gas, Energy, Food and Beverage, Water and Wastewater, Chemical, Petrochemical, Pharmaceutical, Metal, and Mining and Mineral applications.

Embodiments of the present disclosure may comprise a special purpose computer including a variety of computer hardware, as described in greater detail herein.

For purposes of illustration, programs and other executable program components may be shown as discrete blocks. It is recognized, however, that such programs and components reside at various times in different storage components of a computing device, and are executed by a data processor(s) of the device.

Although described in connection with an example computing system environment, embodiments of the aspects of the invention are operational with other special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the example operating environment. Examples of computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the aspects of the present disclosure may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the present disclosure may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor-executable instructions (e.g., software, firmware, and/or hardware) such as those illustrated herein to implement aspects of the invention.

Embodiments may be implemented with processor-executable instructions. The processor-executable instructions may be organized into one or more processor-executable components or modules on a tangible processor readable storage medium. Also, embodiments may be implemented with any number and organization of such components or modules. For example, aspects of the present disclosure are not limited to the specific processor-executable instructions or the specific components or modules illustrated in the figures and described herein. Other embodiments may include different processor-executable instructions or components having more or less functionality than illustrated and described herein.

The order of execution or performance of the operations in accordance with aspects of the present disclosure illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of the invention.

When introducing elements of the invention or embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively, or in addition, a component may be implemented by several components.

The above description illustrates embodiments by way of example and not by way of limitation. This description enables one skilled in the art to make and use aspects of the invention, and describes several embodiments, adaptations, variations, alternatives and uses of the aspects of the invention, including what is presently believed to be the best mode of carrying out the aspects of the invention. Additionally, it is to be understood that the aspects of the invention are not limited in its application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

It will be apparent that modifications and variations are possible without departing from the scope of the invention defined in the appended claims. As various changes could be made in the above constructions and methods without departing from the scope of the invention, it is intended that all matter contained in the above description and shown in the accompanying drawings shall be interpreted as illustrative and not in a limiting sense.

In view of the above, it will be seen that several advantages of the aspects of the invention are achieved and other advantageous results attained.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

What is claimed is:

1. An Intrinsically Safe (IS) Advanced Physical Layer (APL) based low power field device, comprising:
a processor; and
a memory storing processor-executable instructions that, when executed, configure the processor to implement a virtual controller on the field device, the virtual controller configured to provide distributed control and one or more of historian, workstation, and HMI functionality on the field device.

2. The field device of claim 1, further comprising:
one or more analog interfaces for at least one of a current-driven and a voltage-driven Layer 0 device; and
an IS APL connection providing power to the field device and the Layer 0 device.

3. The field device of claim 1, wherein the virtual controller implemented on the field device is configured for managing resources in conjunction with an automated device operating system and application management in an industrial network.

4. The field device of claim 1, wherein the memory further stores processor-executable instructions that, when executed, configure the processor to operate the field device as a managed resource of an industrial network.

5. The field device of claim 1, wherein the memory further stores processor-executable instructions that, when executed, configure the processor to generate a machine-learned model for encapsulating Layer 1 and above control in the field device.

6. The field device of claim 5, wherein the machined-learned model comprises a user-defined function block executed by the processor.

7. The field device of claim 6, wherein the user-defined function block provides an interface to one or more inputs/outputs configured to be connected in a virtual control system for controlling and/or monitoring of a Layer 0 device.

8. The field device of claim 1, wherein the memory further stores processor-executable instructions that, when executed, configure the processor to enable gateway functionality between one or more field device protocols and one or more industrial network protocols.

9. The field device of claim 8, wherein the industrial network protocols are configured to operate the field device as an OPC-UA/FX server with publish/subscribe support for OPC-UA/FX clients.

10. The field device of claim 1, further comprising at least one physical APL 10BaseT1 port connecting the field device to an industrial network an APL switch.

11. The field device of claim 1, further comprising:
an APL Internet Protocol (IP) interface;
one or more galvanically isolated digital inputs coupled to the APL IP interface and configured for coupling one or more external digital circuits to the field device via the APL IP interface; and
one or more galvanically isolated digital outputs coupled to the APL IP interface and configured for coupling the one or more external digital circuits to the field device via the APL IP interface,
wherein the field device is configured for monitoring and controlling the one or more external digital circuits through IP via the APL IP interface.

12. A method comprising:
implementing a virtual controller on an Intrinsically Safe (IS) Advanced Physical Layer (APL) based low power field device; and
providing distributed control and one or more of historian, workstation, and HMI functionality on the field device.

13. The method of claim 12, wherein implementing the virtual controller comprises managing resources in conjunction with an automated device operating system and application management in an industrial network.

14. The method of claim 12, further comprising operating the field device as a managed resource of an industrial network.

15. The method of claim 12, further comprising generating a machine-learned model for encapsulating Layer 1 and above control in the field device.

16. The method of claim 15, wherein the machined-learned model comprises a user-defined function block executed by a processor of the field device.

17. The method of claim 16, wherein the user-defined function block provides an interface to one or more inputs/outputs configured to be connected in a virtual control system for controlling and/or monitoring of a Layer 0 device.

18. The method of claim 12, further comprising:
providing one or more analog interfaces on an APL Internet Protocol (IP) interface for at least one of a current-driven and a voltage-driven Layer 0 device; and
providing power to the APL IP interface and the Layer 0 device via an IS APL connection.

19. The method of claim 18, further comprising enabling gateway functionality between one or more field device protocols and one or more industrial network protocols.

20. The method of claim 19, wherein enabling gateway functionality comprises operating the APL IP interface as an OPC-UA/FX server with publish/subscribe support for OPC-UA/FX clients.

21. The method of claim 18, further comprising:
coupling one or more galvanically isolated digital inputs/outputs the APL IP interface;
coupling one or more external digital circuits to the APL IP interface; and
monitoring and controlling the one or more external digital circuits through IP via the APL IP interface.
